(19) United States
(12) Patent Application Publication
(10) Pub. No.: US 2009/0214863 A1
(43) Pub. Date: Aug. 27, 2009

(54) Polyphenylene Sulfide Coatings

(75) Inventors: Jason L. Kreider, Bartlesville, OK (US); William E. Sattich, Bartlesville, OK (US); Jay Blackburn, Kingwood, TX (US)

Correspondence Address: FLETCHER YODER (CHEVRON PHILLIPS), P. O. BOX 692289, HOUSTON, TX, 77069, US

(73) Assignee: Chevron Phillips Chemical Company LP, The Woodlands, TX (US)

(21) Appl. No.: 12/036,080

(22) Filed: Feb. 22, 2008

(51) Int. Cl. B32B 27/28; B32B 27/12; B29C 47/06; C08K 5/00

(52) U.S. Cl. 428/375; 428/389; 428/419; 264/13; 524/174; 524/175

(57) ABSTRACT

A conductor coating comprising polyphenylene sulfide (PPS), a random copolymer of thylene and glycidyl methacrylate, a thermoplastic ionomer resin, and a metal carboxylate.

### BACKGROUND

1. Field Of The Invention

The present techniques relate generally to polyphenylene sulfide (PPS) blended with other materials to provide compositions having desirable properties such as short-term heat aging resistance, abrasion resistance, and low strip resistance, among other properties when utilized to coat conductors. Exemplary applications for the PPS containing compositions include polymer coatings, conductor coatings, wire coatings, cable coatings, and other applications.

2. Description Of The Related Art

This section is intended to introduce the reader to various aspects of art which may be related to various aspects of the present invention that are described and/or claimed below. This discussion will provide a better understanding of the various aspects of the present invention. Accordingly, it should be understood that these statements are to be read in this light, and not as admissions of prior art.

Polyphenylene sulfide (PPS), a member of a more general class of polymers known as poly(arylene) sulfide (PAS), is a high-performance engineering thermoplastic that may be heated and molded into desired shapes in a variety of manufacturing, commercial, and consumer applications. PPS may be used in the preparation of fibers, films, coatings, injection molding compounds, and fiber-reinforced composites. PPS may be incorporated as a manufacturing component either alone or in a blend with other materials, such as other polymers, resins, reinforcing agents, additives, other thermoplastics, and the like. Initially, PPS was promoted as a replacement for thermosetting materials, but has become a suitable molding material, especially with the addition of glass and carbon fibers, minerals, fillers, and so forth. In fact, PPS is one of the oldest high-performance injection molding plastics in the polymer industry, with non-filled grades commonly extruded as wire coatings.

PPS is an attractive engineering plastic because, in part, it provides an excellent combination of properties. For example, PPS provides for resistance to aggressive chemical environments while also providing for precision molding to tight tolerances. Further, PPS is thermally stable, inherently non-flammable without flame retardant additives, and possesses excellent dielectric/insulating properties. Other properties include dimensional stability, high modulus, and creep resistance. The beneficial properties of PPS are due, in part, to the stable chemical bonds of its molecular structure, which impart a relatively high degree of molecular stability. Consequently, PPS has a high degree of resistance toward thermal degradation and chemical resistance.

Generally, PPS is a polymer comprising at least 70 mole, or alternatively 90 mole %, of para-phenylene sulfide units. The structure for the para-phenylene sulfide unit is provided shown below.

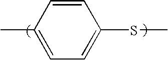

PPS may further comprise up to 30 mole %, or alternatively up to 10 mole %, of recurring units represented by one or more of the following structural formulas:

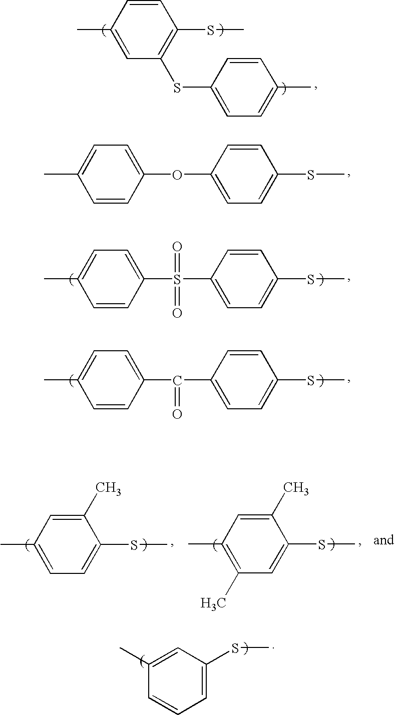

The molecular structure may readily form a thermally stable crystalline lattice, giving PPS a semi-crystalline morphology with a high crystalline melting point ranging from about 265° C. to about 315° C. Because of its molecular structure, PPS also tends to char during combustion, making the material inherently flame resistant. Further, the material may not typically dissolve in solvents at temperatures below about 200° C.

PPS is manufactured and sold under the trade name Ryton® PPS by Chevron Phillips Chemical Company LP of The Woodlands, Tex. Other sources of PPS include Ticona, Toray, and Dainippon Ink and Chemicals, Incorporated, among others.

PPS may be blended or compounded with various additives to provide desired properties. The PPS may be may be heated, melted, extruded, and molded into desired shapes and composites in a variety of processes, equipment, and operations. The PPS may be subjected to heat, compounding, injection molding, blow molding, precision molding, film-blowing, extrusion, and so forth, depending on the desired application.

It should be noted that there is an on-going need for processed polymers and polymer blends having good thermal and abrasion properties. For example, there is a need for conductors coated with an insulating material that can withstand high temperature (e.g., greater than 125° C., 150° C., etc . . . ), maintain flexibility, have good abrasion resistance, and maintain insulating properties when exposed to these temperatures over time (e.g., in vehicle under-the-hood application, etc . . . ). The insulating material should generally not expose the bare underlying wire or conductor via cracking or failure of the insulating material, for example. Additionally, the insulating material should be easily removed (e.g., stripped at the ends) to facilitate the configuration and/or installation of the conductor or wire.

Temperature requirements for the insulation materials of wire and cable used under the hood of automobiles and other vehicles continue to increase. Thermoplastic polyvinyl chloride (PVC) used in high volume in automotive wiring provides chemical and flame resistance, insulation capability, and reasonable toughness, but may not meet the increasing temperature requirements. Moreover, PVC is environmental concern with the difficulties of disposal (e.g., incineration) of the PVC resin. Additionally, PVC is typically not compatible with other plastics used in manufacture of automobiles, which may create problems during recycling operations.

In sum, some of today's wire and conductor coatings require high temperature stability, good chemical and flame resistance, good insulating properties, good low temperature flexibility, and toughness. It should be noted that due to the generally poor flexibility of PPS (as can be seen in low impact strength and low elongation at break), PPS use has been limited in wire and cable applications that require high temperature capability, impact resistance, and flexibility, (e.g. automobile wiring). Consequently, there is a need in the art for a flexible, tough thermoplastic composition with low and high temperature capability, good electricals, and flame retardancy, for use in wire and cable applications, particularly automotive, under-the-hood wiring. An example of an industrial standard describing measurement and/or requirements of vehicular wiring is International Standard ISO 6722 “Road vehicles—60 V and 600 V single-core cables—Dimensions, test methods and requirements.” Individual entities may impose specific test criteria results, specify test modifications, and or additional requirements to the dimensions, test methods, and requirements described with ISO 6722. BMW Group Standard for Low Tension Cables for Motor Vehicles GS 95007-1 of November 2002 (hereafter BMW group standard GS 95007-1) is one such standard which may impose specific test criteria results, specify test modifications, and or additional requirements to the dimensions, test methods, and requirements described with ISO 6722.

### DEFINITIONS

In this disclosure, the word “polymer” relates to a polymer produced from one or more monomers. The word polymer may be further qualified by indicating the class of monomer(s) and/or the specific monomer(s) which minimally must be present in the polymer. For example, a polymer of an olefin describes a polymer comprising units derived from one or more olefins, a polymer of ethylene describes a polymer comprising units derived from ethylene, and a polymer of a hydrocarbon olefin and an epoxy-containing olefin describes a polymer comprising units derived from more or more hydrocarbon olefins and one or more epoxy-containing olefins.

The word “copolymer” relates to polymer produced using two different classes of monomers, two specific monomers, or one class of monomer and one specific monomer. Typically, the word copolymer will be further qualified by indicating the two different classes of monomers, two different specific monomers, or class of monomer and specific monomer used to produce the copolymer. For example, a copolymer of an hydrocarbon olefin and epoxy-containing olefin refers to a copolymer produced from monomers consisting essentially of one or more hydrocarbon olefins and one or more epoxy-containing olefins, a copolymer of ethylene and glycidyl methacrylate refers to a copolymer produced from monomers consisting essentially of ethylene and glycidyl methacrylate, and a copolymer of ethylene and an epoxy-containing olefin refers to a copolymer produced from monomers consisting essentially of ethylene and one or more epoxy-containing olefins. Similarly, the word terpolymer relates to a polymer produced from monomer consisting essentially of three different classes of monomers, two different classes of monomers and a specific monomer, one different class of monomer and two specific monomers, or three different specific monomers.

Abrasion resistance as used herein refers to number of cycles that a coated conductor can maintain its insulating properties as determined by ISO 6722 Section 9.3 scrape abrasion test using a 0.45±0.01 mm diameter needle. Strip force as used herein refers to the amount of force required to remove a 50 mm portion of the insulating material from an end of the conductor. The method for measuring the strip force can either be the force, in Newtons (N), required to remove a 50 mm portion of the insulating material from a 150±5 mm specimen through a piece of sheet metal with a bore equal to the conductor diameter+0.1 mm at a pull off rate 100 mm/min as described in BMW Group Standard GS 95007-1 (November 2002) Section 8.3.1 (hereafter BMW Strip Force) or the force, in Newtons (N), required to remove a 50 mm portion of the insulating material from a 75±5 mm specimen at a pull off rate 250 mm/min using the apparatus and method described in ISO 6722 Section 7.2 (hereafter ISO 6722 Strip Force). Short-term heat aging as used herein is a pass/fail test to determine whether the coating of a coated wire can withstand extended period of time at increased temperature as determined by ISO 6722 Section 10.1. References to the short-term heat aging must further specify the class of the coated conductor as the class defines the test temperature of the coated conductor in the short-term heat aging test. The coating compositions described herein can be utilized to form coated conductors having a Class A, B, C, D, E, F, G, or H rating. All references to ISO 6722 refer to ISO 6722:2002(E).

Nominal thickness as used herein refers to a material (coating) having an average thickness which may vary by up to ±20%. For example a conductor coating having a nominal thickness of 0.6 mm will have an average thickness of about 0.6 mm wherein the thickness may vary from between 0.48 to 7.2 mm along the length of the coated conductor. It should be noted that while the nominal may refer to a maximum variance of the coating, any individual coating may have a variance less than that referenced by the word nominal. That is, a coating may have an average thickness which may vary less than ±20%.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present techniques are directed to polyphenylene sulfide compositions where PPS may be blended with other components to produce compositions having desirable properties. Non-limiting exemplary properties which the herein described PPS composition may have include increased abrasion resistance and increased thermal stability (e.g. capable of withstanding temperatures up to 150° C. and higher), among other properties. Exemplary applications for the polyphenylene sulfide compositions described herein include coatings such as conductor coatings, wire coatings, and/or cable coatings, among other applications. These PPS polyphenylene compositions may be a suitable replacement for polyvinylchloride, PVC, and polyolefin compositions in coating applications where these other polymer based compositions may fail one or more performance criteria (e.g. high temperature stability and abrasion resistance, among other criteria).

A specific area of applications involve conductors coated with an insulating material that can withstand high temperature (e.g., greater than 85±2° C., 100±2° C., 125±3° C., 150±3° C., 175±3° C., 200±3° C., 225±3° C., as specified for Class A, B, C, D, E, F, or G coated conductors, respectively) and maintain flexibility, abrasion resistance, and/or conductivity when exposed to these temperatures over time. A particular exemplary application is under-the-hood wiring in vehicles. Beneficially, as discussed below, the strip force of the PPS coatings is also adequate, which may facilitate removal of the insulating material from the conductor.

These new PPS blends and coatings are formulated in an effort to satisfy ever-increasing demands for conductor coatings (electrically insulating materials), such as in the automotive industry and may meet certain industry standards, such as the BMW Group Standard GS 95007-1 (November 2002) and International Standard ISO 6722 “Road vehicles −60 V and 600 V single-core cables—Dimensions, test methods and requirements.” However, it should be noted that the present formulations and techniques are not limited to satisfying any industry requirement or standard.

The present PPS composition comprises a blend of: (1) PPS; (2) a polymer of a hydrocarbon olefin and an epoxy-containing olefin; and (3) a thermoplastic ionomer resin. The PPS compositions described herein may also advantageously contain additional agents such a metal carboxylates and/or organic bisphosphates. These PPS compositions may have desirable abrasion resistance properties, short-term heat aging properties, and/or strip force properties.

The PPS utilized in the PPS compositions is not particular limited beyond the requirement that the PPS contains at least 70 mole %, or alternatively 90 mole %, percent of the structural unit indicated below.

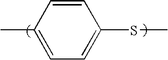

The PPS may further comprise up to 30 mole %, or alternatively up to 10 mole % of recurring units represented by one or more of the following structural formulas:

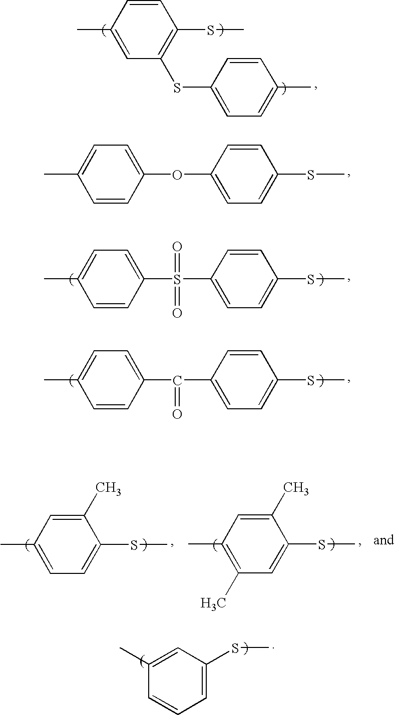

PPS may additionally comprise other units which may modify or improve its properties as long as the PPS comprises the minimum quantity of recurring units as recited herein.

The PPS which may be utilized are known to those having ordinary skill in the art and are commercially available. One commercial source PPS is Chevron Phillips Chemical Company, LP, located in The Woodlands, Tex. Other sources of PPS inclucde Ticona, Toray, and Dainippon Ink and Chemicals, Incorporated, among others.

In the present compositions, the polymer of hydrocarbon olefin and an epoxy-containing olefin which may be utilized may include: (1) a polymer of a hydrocarbon olefin and an epoxy-containing olefin; and/or (2) a polymer of an hydrocarbon olefin, an epoxy-containing olefin, and an alkyl ester of an α,β-unsaturated carboxylic acid. The polymer may be: (1) a copolymer of a hydrocarbon olefin and an epoxy-containing olefin; or (2) a terpolymer of hydrocarbon olefin, an alkyl ester of an α,β-unsaturated carboxylic acid, and an epoxy-containing olefin.

The hydrocarbon olefin that may be polymerized with the epoxy-containing olefin may to form the polymer, copolymer, and/or terpolymer may be a hydrocarbon alpha-olefin. In certain embodiments, the hydrocarbon alpha olefin has from 2 to 10 carbon atoms. The hydrocarbon alpha olefin may be ethylene or propylene, for example.

The epoxy-containing olefin that may be polymerized with the hydrocarbon olefin to form the polymer, copolymer, and/or terpolymer of the present compositions may be a glycidyl ester of an α,β-unsaturated carboxylic acid. The α,β-unsaturated carboxylic acid portion of the alkyl ester or glycidyl ester may be derived from an acrylic acid. Particular acrylic acids of the alkyl ester or glycidyl ester of an α,β-unsaturated carboxylic acids may have from 3 to 10 carbon atoms. The α,β-unsaturated carboxylic acid portion of the alkyl ester or glycidyl ester may be derived from acyrlic acid and/or methacrylic acid, for example. Suitable glycidyl esters of an α,β-unsaturated carboxylic acid include glycidyl acrylate and/or glycidyl methacrylate. The alkyl group of the alkyl ester of an α,β-unsaturated carboxylic acid may have from 1 to 10 carbon atoms. Suitable alkyl esters of an α,β-unsaturated carboxylic acid include methyl acrylate, ethyl acrylate, n-propyl acrylate, iso-propyl acrylate, n-butyl acrylate, methyl methacrylate, ethyl methacrylate, n-propyl methacrylate, iso-propyl methacrylate, and/or n-butyl methacrylate. In certain instances, the suitable alkyls ester is more beneficially methyl acrylate and/or methyl methacrylate, or methyl acrylate, or methyl methacrylate, and so on.

Suitable polymers of a hydrocarbon olefin and an epoxy-containing olefin include: (1) a copolymer of ethylene and glycidyl acrylate; (2) a copolymer of ethylene and glycidyl methacrylate; (3) a terpolymer of ethylene, n-butyl acrylate, and glycidyl acrylate; (4) a terpolymer of ethylene, methyl acrylate, and glycidyl acrylate; (5) a terpolymer of ethylene, n-butyl acrylate, and glycidyl methacrylate; and (6) a terpolymer of ethylene, methyl acrylate, and glycidyl methacrylate.

A particularly advantageous polymer of a hydrocarbon olefin and an epoxy-containing olefin is a copolymer of ethylene and glycidyl methacrylate. Moreover, in the present formulations, the polymer of the hydrocarbon olefin and epoxy-containing compound, whether the polymer is a general polymer, copolymer or terpolymer, may be a random polymer, random copolymer, or random terpolymer. In certain embodiments, the polymer, copolymer, or terpolymer may be formed via a free-radical polymerization process, such as a high-pressure free-radical polymerization process.

The polymer of a hydrocarbon olefin and an epoxy-containing olefin, be it a general polymer, copolymer, or terpolymer, may contain, from about 45 to about 99 weight %, from about 55 to about 97 weight %, or from about 65 to about 95 weight % hydrocarbon olefin. The polymer of a hydrocarbon olefin and an epoxy-containing olefin, be it general polymer, copolymer, or terpolymer, may contain from about 1 to about 20 weight %, from about 3 to about 15 weight %, or from about 5 to about 13 weight % monomer derived from the epoxy-containing olefin. The polymer of the polymer of an hydrocarbon olefin, an epoxy-containing olefin, and an alkyl ester of an α,β-unsaturated carboxylic acid, be it a general polymer or terpolymer, may contain: from about 1 to about 20 weight %, from about 3 to about 15 weight %, or from about 5 to about 13 weight % of monomer derived from the epoxy-containing olefin; and also, from about 3 to about 35 weight %, from about 5 to about 30 weight %, or from about 7 to about 25 weight % of the alkyl ester of an α,β-unsaturated carboxylic acid.

The thermoplastic ionomer resin may be a metal salt of a polymer of a hydrocarbon olefin and an α,β-unsaturated carboxylic acid, or alternatively, a metal salt of a polymer of a hydrocarbon olefin, an α,β-carboxylic acid, and an alkyl ester of an α,β-unsaturated carboxylic acid. In certain embodiments, the thermoplastic ionomer resin may be a metal salt of a copolymer of a hydrocarbon olefin and an α,β-unsaturated carboxylic acid; or alternatively, a metal salt of a terpolymer of a hydrocarbon olefin, an α,β-carboxylic acid, and an alkyl ester of an α,β-unsaturated carboxylic acid. In various embodiments, the hydrocarbon olefin of the thermoplastic ionomer resin is a hydrocarbon alpha-olefin. In certain examples, the hydrocarbon alpha olefin of the thermoplastic ionomer resin may have from 2 to 10 carbon atoms, or alternatively from 2 to 4 carbon atoms. Particular exemplary hydrocarbon alpha olefins of the thermoplastic ionomer resin may include ethylene or propylene. In an embodiment, the α,β-carboxylic acid of the thermoplastic ionomer resin is acrylic acid and/or methacrylic acid. The alkyl ester of an α,β-carboxylic acid used in the thermoplastic ionomer resin may have the same or similar embodiments as the alkyl ester of an used in the polymer of an hydrocarbon olefin, epoxy-containing olefin, an alkyl ester of an α,β-carboxylic acid described herein. The metal of the thermoplastic ionomer resin may be Li, Na, K, Ca, Mg, Zn, Al, or mixtures thereof. In one instance the metal is sodium (Na). In another instance, the metal is potassium (K). In yet another instance, the metal is zinc (Zn).

Generally, the thermoplastic ionomer resin, whether a general polymer, copolymer or terpolymer, may incorporate at least about 50 weight %, about 60 weight %, or about 70 weight % hydrocarbon olefin. The thermoplastic ionomer resin, whether a general polymer, copolymer or terpolymer, may incorporate from about 2 to about 25 weight %, about 4 to about 20 weight %, or about 5 to about 15 weight % of α,β-unsaturated carboxylic acid. The thermoplastic ionomer resin, whether a general polymer, or terpolymer, may further include from about 1 to about 40 weight %, about 2 to about 30 weight %, or about 3 to about 25 weight % of an alkyl ester of α,β-unsaturated carboxylic acid. Generally, from about 1 to about 100%, from about 10 to about 90%, or from about 30 to about 70 weight % of the carboxylic acid groups in the thermoplastic ionomer resin have been neutralized with the metallic base to provide the metal.

Suitable thermoplastic ionomer resins may include a metal salt of a polymer of ethylene and an acrylic acid, a copolymer of ethylene and an acrylic acid, and a terpolymer of ethylene, an acrylic acid, and an alkyl ester of an acylic acid. Non-limiting examples, of specific thermoplastic ionomer resins which may be utilized include a metal salt of a copolymer of ethylene and acrylic acid, copolymer of ethylene and metacrylic acid. Surlyn®, a random copolymer ethylene and methacrylic acid, is non-limiting example of a commercial thermoplastic ionomer resin which may be utilized. Surlyn® is commercially available from DuPont™, of Wilmington, Del. Other thermoplastic ionomer resin which may be utilized are known to those having ordinary skill in the art.

The metal carboxylate(s) may be any metal carboxylate derived by neutralizing a carboxylic acid with a metallic base. In an embodiment, the metal carboxylate may be derived from a carboxylic acid having from 10 to 40 carbon atoms; or alternatively, from 15 to 30 carbon atoms. A suitable carboxylic acid is stearic acid. Consequently, a suitable metal carboxylate may be a metal stearate. The metal atom of the metal carboxylate may be Mg, Ca, Zn, or Sn; or alternatively, Zn. An exemplary metal carboxylate which can be utilized is zinc stearate.

The organic bisphosphate may be any organic bisphosphate having two phosphate groups. Overall, the organic bisphosphate may have from 15 to 70 carbon atoms; alternatively, from 20 to 60 carbon atoms; or alternatively, from 25 to 50 carbon atoms. Generally, the organic bisphosphate is a bis ester of a diol (i.e. a bis(dihydrocarbyl phosphate). The diol from which the bis(dihydrocarbyl phosphate ester) may be derived may be aliphatic or aromatic and may have from 2 to 15 carbon atoms; or alternatively from 6 to 10 carbon atoms. In some embodiments, the diol from which the bis(dihydrocarbyl phosphate ester) may be derived may be a dihydroxybenzene. In an embodiment, the diol from which the bis(dihydrocarbyl phosphate ester) may be derived may be resorcinol. The hydrocarbyl groups of the bis(dihydrocarbyl phosphate ester) may be aliphatic or aromatic and may have from 3 to 20 carbon atoms; alternatively, from 6 to 10 carbon atoms. For example, the bisphosphate may be tetraphenyl resorcinol diphosphate, which is commercially available as REOFOS® RDP REOFOS® RDP is available from Great Lakes Chemical Corporation (now Chemtura Corporation) of Middlebury, Conn.

Generally, the quantities of the PPS, polymer of a hydrocarbon olefin and a epoxy-containing olefin, thermoplastic ionomer resin, metal carboxylate (if present), and bisphosphate (if present) of the PPS composition are those quantities necessary to provide a desirable property in a selected application. One potential application of the PPS compositions described herein include a coating for a conductor.

The quantity of PPS, which may be present in the PPS compositions, can range from about 40 to about 90, from about 45 to about 80, or from about 50 to about 70 weight %. The quantity of polymer of a hydrocarbon olefin and an epoxy-containing olefin utilized in the PPS composition can range from about 5 to about 50, from about 15 to about 45, or about 20 to about 40 weight %. The quantity of thermoplastic ionomer resin, which may be utilized in the PPS compositions, may range from about 0.5 to about 25, from about 1 to about 20, or from about 2 to about 15 weight %. The quantity of metal carboxylate, if present, utilized in the PPS composition may range from about 0 to about 5, from about 0.25 to about 4, or from about 0.5 to about 3 weight %. The quantity of the biphosphate, if present, utilized in the PPS composition may range from 0 to about 5, from about 0.25 to about 4, or about 0.5 to about 3 weight %. In some embodiments, the weight ratio thermoplastic ionomer resin to polymer of a hydrocarbon olefin and epoxy-containing olefin may range from 1:2 to 1:10, from 1:3 to 1:8, or 1:4 to 1:6. One of ordinary skill in the art recognizes that the PPS compositions can include other ingredients as are customarily used in the conventional compounding of thermoplastics. Examples of such other ingredients include carbon black, metal deactivators, glass fibers, graphite fibers, DuPont Kevlar® aramid fibers, glass spheres, plasticizers, lubricants, silica, titanium dioxide, pigments, clay, mica, and other mineral fillers, flame retardants, antioxidants, ultraviolet stabilizers, heat stabilizers, processing aids, adhesives, and tackifiers.

The PPS, polymer of an hydrocarbon olefin and an epoxy-containing olefin, thermoplastic ionomer resin, metal carboxylate, and bisphosphate utilized in the PPS compositions, along with the quantities of each of these components in the PPS composition have been described independently herein. These components and quantities may be utilized in any combination to describe compositions that meet the desired property or properties described herein. The PPS composition may further include other additives as described herein.

The PPS composition can be blended and then extruded using known techniques to produce pellets which may be easily stored and transported. The PPS composition pellets may then be used to produce coated conductor using techniques known to those skilled in the art. One such non-limiting technique is to extrude the coating at a desired thickness over a conductor having a desired diameter.

The PPS compositions may have desirable properties for certain applications. For example the PPS composition described herein may be used as a coating for conductors. These desirable properties may be measured by applying the coating to a specified conductor at a specified thickness. However, unless specifically indicated, the coating composition is not limited to the conductor, conductor properties, and/or coating thickness utilized to indicate the desirable property or properties. The specified conductor, conductor properties, and/or coating thickness are indicated to provide a consistent basis on which to base the desirable property or properties. One method of determining whether the coating composition has the desirable property or properties may be exemplified by applying the coating to a conductor having a cross-sectional area of 0.35 mm² at a nominal thickness of 0.25 mm to produce a coated conductor which is tested to determine whether conductor coating has the specified property. A second method of determining whether the coating composition has the desirable property or properties may be exemplified by applying the coating to a conductor having a cross-sectional area of 0.50 mm² at a nominal thickness of 0.28 mm to produce a coated conductor which is the tested to determine whether conductor coating has the specified property. Alternative conductor cross-sectional area and coating nominal thickness, which may be used to exemplify the desirable properties when the coating composition is applied to a conductor having a specified cross-sectional area at a specified nominal thickness, may be utilized and are represented by any other conductor cross-sectional area and coating nominal thickness combination described herein.

The PPS compositions described herein can be applied to a conductor to produce a coated conductor having certain desirable properties. The desirable properties of the coating on the coated conductor may include, either singly or in any combination, scrape abrasion resistance, a strip force, a reduction in strip force as compared against a different coating composition, and an ability to pass a short-term heat aging test. Measurement techniques and criteria for scrape abrasion resistance, strip force, and short-term heat aging are discussed and referenced herein.

Generally, scrape abrasion resistance is the ability of a coating to resist abrasion and maintain its insulating properties over the coated conductor. Scrape abrasion resistance may be measured by subjecting a coated conductor to the method described in ISO 6722 and determining the number of cycles that the coating can maintain its insulating properties.

A determination on whether a particular coating composition may be able to produce a coated conductor having a particular abrasion resistance when applied to a conductor may be made by applying the coating composition to a specified conductor at a specified coating thickness. One method for determining whether a coating composition has a desirable scrape resistance property may be made by applying the coating to a conductor having a cross-sectional area of 0.35 mm at a nominal thickness of 0.25 mm to produce a coated conductor and determining the number of cycles the coating can maintain its insulating properties. A second method for determining whether a coating composition has a desirable scrape resistance property may be may made by applying the coating to a conductor having a cross-sectional area of 0.50 mm² at a nominal thickness of 0.28 mm to produce a coated conductor and determining the number of cycles the coating can maintain its insulating properties.

Advantageously, PPS compositions described herein comprising (but not limited to) PPS, and a copolymer of ethylene and glycidyl methacrylate when applied to coat a conductor having a cross-sectional area of 0.35 mm² at a nominal thickness of 0.25 mm may provide a coated conductor having a scrape abrasion resistance of at least 200, 300, 400, 500, or 600 cycles per ISO 6722. Alternatively, PPS compositions described herein comprising (but not limited to) PPS, and a copolymer of ethylene and glycidyl methacrylate when applied to a conductor having a cross-sectional area of 0.50 mm² at a nominal thickness of 0.28 mm may provide a coated conductor having a scrape abrasion resistance of at least 300, 450, 600, 750, or 900 cycles per ISO 6722. Alternative combinations of conductor cross-sectional area, coating nominal thickness, and minimum number of cycles completed under the scrape abrasion resistance test include those provided in Table 1. In addition, certain present PPS compositions incorporating PPS and a copolymer of ethylene and glycidyl methacrylate, which when applied to a conductor having a specified cross-sectional area at a specified nominal thickness and having an abrasion resistance of a specified minimum of cycles per ISO 6722 may further contain metal carboxylate and/or a bisphosphate, as described herein. The PPS composition may further include other additives as described herein.

TABLE 1
Combinations of Conductor Cross-Sectional Area, Coating
Nominal Thickness, and minimum number of cycles completed
under the scrape abrasion resistance test

| | Conductor Cross-Sectional Area, mm² | | | | | | | | |
|---|---|---|---|---|---|---|---|---|---|
| | 0.22 | 0.35 | 0.5 | 0.75 | 1.0 | 1.5 | 2.5 | 4.0 | 6.0 |
| | Coating Nominal Thickness, mm | | | | | | | | |
| | 0.25 | 0.25 | 0.28 | 0.30 | 0.30 | 0.30 | 0.35 | 0.40 | 0.40 |
| Potential Minimum | 150 | 200 | 300 | 350 | 500 | 1500 | 1500 | 1500 | 1500 |
| Number of Scrape | 225 | 300 | 450 | 525 | 750 | 2250 | 2250 | 2250 | 2250 |
| Abrasion Resistance | 300 | 400 | 600 | 700 | 1000 | 3000 | 3000 | 3000 | 3000 |
| Cycles per ISO 6722 | 375 | 500 | 750 | 875 | 1250 | 3750 | 3750 | 3750 | 3750 |
| | 450 | 600 | 900 | 1050 | 1500 | 4500 | 4500 | 4500 | 4500 |

Particularly useful compositions capable of completing the herein described number of cycles under the scrape abrasion resistance test of ISO 6722 comprise PPS, a copolymer of ethylene and glycidyl methacrylate, and a thermoplastic ionomer resin. In an embodiment, the PPS composition capable of completing the herein described number of cycles under the scrape abrasion resistance test of ISO 6722 comprise from about 40 to about 90 weight % by weight PPS, from about 5 to about 50 weight % copolymer of ethylene and glycidyl methacrylate, and from about 0.5 to about 25 weight % thermoplastic ionomer resin. Other compositions which may be capable of completing the herein described number of cycles under the scrape abrasion resistance test of ISO 6722 would be readily apparent based upon the present disclosure. The PPS composition PPS composition capable of completing the herein described number of cycles under the scrape abrasion resistance test of ISO 6722 may further advantageously include a metal carboxylate and/or a bisphosphate.

Generally, strip force is the amount of force required to remove a portion of the insulating material from an end of the coated wire, cable or conductor. Strip force may be measured by subjecting a coated conductor to the method described in BMW Group Standard GS 95007-1 (November 2002) Section 8.3.1, BMW strip force, or to the method described in ISO 6722 Section 7.2, ISO 6722 strip force, and determining the amount of force required to remove a portion of the insulating material from an end of the coated conductor.

A determination on whether a particular coating composition may be able to produce a coated conductor having a particular strip force when applied to a conductor may be made by applying the coating composition to a specified conductor at a specified coating thickness. Features of the conductor, the feature of the coating thickness, and strip force, which may be utilized in the determination of whether a coating composition has the specified strip force are described herein. One method for determining whether a coating composition has a desirable scrape resistance property may be may made by applying the coating to a conductor having a cross-sectional area of 0.35 mm² at a nominal thickness of 0.25 mm to produce a coated conductor and determining the force require to remove a portion of the coating from the conductor. A second method for determining whether a coating composition has a desirable strip force may be may made by applying the coating to a conductor having a cross-sectional area of 0.50 mm² at a nominal thickness of 0.28 mm to produce a coated conductor and determining the force required to remove a portion of the coating from the conductor. The method utilized to measure the strip force may be either BMW Group Standard GS 95007-1 (November 2002) Section 8.3.1, BMW Strip Force, or ISO 6722 Section 7.2, ISO 6722 Strip Force.

PPS compositions described herein comprising (but not limited to) PPS, and a copolymer of ethylene and glycidyl methacrylate when applied to coat a conductor having a cross-sectional area of 0.35 mm² at a nominal thickness of 0.25 mm may provide a coated conductor having a ISO 6722 or BMW strip force of less than 40, 35, 30, or 25 N; alternatively, a ISO 6722 or BMW strip force between 5 and 40 N, 5 and 35 N, 5 and 30 N, or 5 and 25 N. Alternatively, PPS compositions described herein comprising (but not limited to) PPS, and a copolymer of ethylene and glycidyl methacrylate when applied to a conductor having a cross-sectional area of 0.50 mm² at a nominal thickness of 0.28 mm may provide a coated conductor having a ISO 6722 or BMW strip force of less than 40, 35, 30, or 25 N; alternatively a ISO 6722 or BMW strip force between 5 and 40 N, 5 and 35 N, 5 and 30 N, or 5 and 25 N. Alternative combinations of conductor cross-sectional area, coating nominal thickness, and maximum ISO 6722 or BMW strip force, or combination of range of minimum to maximum ISO 6722 or BMW strip force are provided in Table 2. In addition, certain PPS compositions incorporating PPS and a copolymer of ethylene and glycidyl methacrylate, which when applied to a conductor having a specified cross-sectional area at a specified nominal thickness and having an abrasion resistance of a specified minimum of cycles per ISO 6722 may further contain metal carboxylate and/or a bisphosphate, as described herein.

TABLE 2
Combinations of Conductor Cross-Sectional Area, Coating
Nominal Thickness, and ISO or BMW Strip Force.

| | Conductor Cross-Sectional Area, mm² | | | | | | | | |
|---|---|---|---|---|---|---|---|---|---|
| | 0.22 | 0.35 | 0.5 | 0.75 | 1.0 | 1.5 | 2.5 | 4.0 | 6.0 |
| | Coating Nominal Thickness, mm | | | | | | | | |
| | 0.25 | 0.25 | 0.28 | 0.30 | 0.30 | 0.30 | 0.35 | 0.40 | 0.40 |
| Minimum Strip Force, N | 3 | 5 | 5 | 5 | 5 | 10 | 10 | 10 | 10 |
| Potential Maximum | 30 | 40 | 40 | 50 | 50 | 60 | 70 | 80 | 80 |
| Strip Force, N, | 25 | 35 | 35 | 45 | 45 | 50 | 60 | 70 | 70 |
| per ISO 6722 or | 20 | 30 | 30 | 40 | 40 | 45 | 55 | 65 | 65 |
| BMW Group Standard | 15 | 25 | 25 | 35 | 35 | 40 | 50 | 60 | 60 |
| GS 95007-1 | | | | | | | | | |

Generally, the PPS compositions, which can coat a conductor to produce a coated conductor having the herein described strip force, include PPS, a polymer of a hydrocarbon olefin and a epoxy-containing compound, and a thermoplastic ionomer resin. However, there is generally a delicate balance between increasing the abrasion resistance of the coating and maintaining a strip force for a conductor coated with a PPS compositions incorporating PPS, a polymer of a hydrocarbon olefin and a epoxy-containing compound, and a thermoplastic ionomer resin. Increased strip force could represent a disadvantage for conductors coated with PPS compositions comprising PPS, a polymer of a hydrocarbon olefin and an epoxy-containing compound, and a thermoplastic ionomer resin unless an agent capable of reducing the strip force is added to the PPS composition. Consequently, particular agents are beneficial to decrease the strip force for the present compositions when applied to a conductor. Such agents may produce a coating composition capable of providing a coated conductor having an acceptable force to remove the coating from the coated conductor.

Advantageously, when a quantity of metal carboxylate is added to a PPS composition comprising PPS, a polymer of a hydrocarbon olefin and an epoxy-containing compound, and a thermoplastic ionomer resin, the strip force required to remove the PPS composition from the coated conductor is lowered. Generally, while it might be assumed in the art that any typical lubricant would provide an acceptable lowering of the strip force when included in the PPS composition used to coat the conductor, this is not the case. In accordance with the present techniques, all lubricants do not provide meaningful reductions in the strip force when conductors are coated with the herein described PPS compositions. In fact, it has been discovered that metal carboxylates (e.g. zinc stearate) provide significantly better performance for lowering the strip force than other resin composition lubricants such as siloxanes and perfluorinated resins.

In an embodiment, a conductor coated with a PPS composition comprising PPS, a polymer of a hydrocarbon olefin and an epoxy-containing compound, a thermoplastic ionomer resin, and a metal carboxylate has a strip force that is decreased by at least 15%, 20%, 25%, or 30% as compared to the same formulation substantially devoid of a metal carboxylate. Alternatively, in an embodiment, a method of decreasing the strip force of a conductor coated with a PPS composition comprising PPS, a polymer of a hydrocarbon olefin and an epoxy-containing compound, and a thermoplastic ionomer resin, including a metal carboxylate in the PPS composition. In some embodiments, the strip force of the PPS composition coated conductor is decreased by at least 15%, 20%, 25%, or 30%. The herein described lowering of the strip force for removing a portion of the coating from a coated conductor may be a property of the coated conductor or may be utilized as a test to determine whether a PPS composition comprising PPS, a polymer of a hydrocarbon olefin and an epoxy-containing compound, a thermoplastic ionomer resin, and a metal carboxylate provides an acceptable reduction in strip force when the coating is applied to any specified conductor described herein and any nominal thickness as described herein (e.g. a conductor having a cross-sectional area of 0.35 mm² at a coating nominal thickness of 0.25 mm or a conductor having a cross-sectional area of 0.50 mm² at a coating nominal thickness of 0.28 mm). BMW strip force or ISO 6722 strip force may be utilized for determining whether the addition of a metal carboxylate to the PPS composition provides the herein specified decrease in strip force.

Generally, short-term heat aging refers to test which determines the ability of a conductor coating to maintain its insulating properties over a coated conductor then exposed to a specified temperature over a specified period of time. Short-term heat aging is a pass/fail test which is measured according to the method described in ISO 6722 Section 10.1. In an embodiment, a conductor coated with a PPS composition comprising PPS, a copolymer of ethylene and glycidyl methacrylate can pass the short-term heat aging test per ISO 6722. In some embodiments, the PPS composition comprising PPS, a copolymer of ethylene and glycidyl methacrylate coating the conductor further comprises a bisphosphate and/or a metal carboxylate. In further embodiments, a PPS composition comprising PPS, a terpolymer of hydrocarbon olefin, an alkyl ester of an α,β-unsaturated carboxylic acid, and an epoxy-containing olefin, a thermoplastic ionomer resin and a bisphosphate may be utilized to coat a conductor (e.g. wire or cable), or coating may pass the short-term heat aging test per ISO 6722. In a further embodiment, the PPS composition comprising PPS, terpolymer of hydrocarbon olefin, an alkyl ester of an α,β-unsaturated carboxylic acid, and an epoxy-containing olefin, a thermoplastic ionomer resin an a bisphosphate which coats the conductor may further comprise a metal carboxylate. The short-term heat aging test may be a property of a coated conductor or may be utilized as a test to determine whether a PPS composition described herein can pass the short-term heat aging when applied to any specified conductor described herein and any nominal thickness as described herein (e.g. a conductor having a cross-sectional area of 0.35 mm² at a coating nominal thickness of 0.25 mm or a conductor having a cross-sectional area of 0.50 mm² at a coating nominal thickness of 0.28 mm).

In various embodiments, a conductor coated with a PPS composition comprising PPS, copolymer of hydrocarbon olefin and an epoxy-containing olefin, a thermoplastic ionomer resin may, either singly or in any combination, complete any number of abrasion resistance cycles described herein, have any strip force described herein, have any reduction in strip force as described herein, and pass the short-term heat aging test. The scrape abrasion resistance test, the strip force test, a reduction in strip force, and short-term thermal aging test may utilized, either singly or in any combination, as a test to determine whether a PPS composition comprising PPS, copolymer of hydrocarbon olefin and an epoxy-containing olefin, a thermoplastic ionomer resin when applied to any specified conductor described herein at any nominal thickness described herein may be able to complete any number of abrasion resistance cycles described herein, have any strip force described herein, have any reduction in strip force as described herein and/or pass the short-term heat aging test. Such PPS compositions may further comprise a metal carboxylate and/or a bisphosphate.

The PPS compositions described herein may be utilized to make a coated conductor. Generally, the coated conductor comprises a conductor and an insulating coating. The conductor of the coated conductor may be described utilizing any combination of features including the metal of the conductor and features of the metal of the conductor (such as number of wires, whether the conductor is coated, or whether the conductor is annealed, among other features). The conductor may comprise any metal. In some embodiments the conductor may comprise, or consist essentially of, copper. In other embodiments the conductor may be a copper alloy. In some particular embodiments, a copper conductor may be a hard-drawn copper, soft annealed copper, or hard unannealed copper. In other embodiments, the conductor comprising copper may be tin-coated; alternatively, silver-coated; or alternatively, nickel coated. The conductor may comprise a single wire or comprise multiple wire strands. The conductor may further be described as having a diameter and/or cross-sectional area. In an embodiment, the conductor may be symmetric; or alternatively, unsymmetric. The PPS compositions that may be utilized to coat the conductor is generally described here and any PPS composition described herein may be utilized to produce a coated conductor utilizing any conductor described herein.

Generally, the conductor may have any diameter. In an embodiment, the diameter of the conductor, whether the conductor comprises a single wire or multiple wire strands, may have a diameter ranging from 0.45 to 5 mm; alternatively from 0.45 to 1 mm; alternatively, ranging from 1 to 2.1 mm; alternatively, range from 2.1 to 3.25 mm; or alternatively, ranging from 3.25 to 5 mm.

Generally, the conductor may have any cross-sectional area. In an embodiment, the conductor may have a cross-sectional area ranging from 0.10 to 13 mm². In some embodiments, the conductor may have a cross-sectional area ranging from 0.10 to 0.16 mm², 0.18 to 0.26 mm², 0.30 to 0.40 mm², 0.44 to 0.56 mm², 0.65 to 0.85 mm², 0.9 to 1.10 mm², 1.30 to 1.70 mm², 1.8 to 2.2 mm², 2.30 to 2.70 mm², 2.80 to 3.20 mm², 3.75 to 4.25 mm², 4.70 to 5.30 mm², 5.60 to 6.4 mm², 9.00 to 11.0 mm². Alternatively, the conductor may a cross-sectional area of about 0.13 mm², about 0.22 mm², about 0.35 mm², about 0.50 mm², about 0.75 mm², about 1 mm², about 1.5 mm², about 2 mm², about 2.5 mm², about 3 mm², 4 mm², about 5 mm², about 6 mm², or about 10 mm².

Generally, the conductor may be described as having any combination of conductor diameter described herein and any conductor cross-sectional area described herein. Some particular common conductor cross-sectional area and diameter combinations include a conductor cross-sectional area of about 0.13 mm² with a maximum diameter of 0.55 mm, a conductor cross-sectional area of about of about 0.22 mm² with a maximum diameter of 0.70 mm, a conductor cross-sectional area of about of about 0.35 mm² with a maximum diameter of 0.90 mm, a conductor cross-sectional area of about 0.50 mm² with a maximum diameter of 1.10 mm, a conductor cross-sectional area of about 0.75 mm² with a maximum diameter of 1.30 mm, a conductor cross-sectional area of about 1 mm² with a maximum diameter of 1.50 mm, a conductor cross-sectional area of about 1.5 mm² with a maximum diameter of 1.80 mm, a conductor cross-sectional area of about 2 mm² with a maximum diameter of 2.00 mm, a conductor cross-sectional area of about 2.5 mm² with a maximum diameter of 2.20 mm, a conductor cross-sectional area of about 3 mm² with a maximum diameter of 2.40 mm, a conductor cross-sectional area of about 4 mm² with a maximum diameter of 2.80 mm, a conductor cross-sectional area of about 5 mm² with a maximum diameter of 3.10 mm, a conductor size of 6 mm² with a maximum diameter of 3.40 mm, and a conductor cross-sectional area of about 10 mm² with a maximum diameter of 4.50 mm.

The insulating coating of coated conductor may have any thickness necessary for its particular application. The coating thickness may have a nominal thickness ranging from 0.15 to 1.2 mm. In particular embodiments, the conductor coating may have a nominal thickness ranging from 0.18 to 0.22 mm; alternatively, from 0.23 to 0.27 mm; alternatively, from 0.26 to 0.30 mm; alternatively, from 0.28 to 0.32 mm; alternatively, from 0.33 to 0.37 mm; alternatively, from 0.38 to 0.42 mm; alternatively, from 0.55 to 0.65 mm; alternatively, from 0.65 to 0.75 mm; alternatively, from 0.75 to 0.85 mm; or alternatively, from 0.9 to 1.10 mm. In other embodiments, the coating may have a nominal thickness of about 0.2 mm; alternatively, about 0.25 mm; alternatively, about 0.28 mm; alternatively, about 0.3 mm; alternatively, about 0.35 mm; alternatively, about 0.40 mm; alternatively, about 0.60 mm; alternatively, about 0.70 mm; alternatively, about 0.80; or alternatively, about 1.00 mm.

The coated conductor may be generally described as any conductor described herein having any combination of any conductor cross-sectional area described herein and/or conductor diameter described herein and having any coating nominal thickness as described herein. Generally, for many applications, the coating nominal thickness increases with the conductor cross-sectional area and/or diameter. Some non-limiting conductor cross-sectional area and insulating coating nominal thickness combinations include a conductor having a cross-sectional area ranging from 0.10 to 0.16 mm², from 0.18 to 0.26 mm², from 0.30 to 0.40 mm², from 0.44 to 0.56 mm², from 0.65 to 0.85 mm², from 0.9 to 1.10 mm², or from 1.30 to 1.70 mm² with an insulating coating nominal thickness ranging from 0.18 to 0.22 mm; alternatively, a conductor cross-sectional area ranging from 0.10 to 0.16 mm², from 0.18 to 0.26 mm², or from 0.30 to 0.40 mm² with an insulating coating nominal thickness ranging from 0.23 to 0.27 mm; alternatively, a conductor cross-sectional area ranging from 0.30 to 0.40 mm² with an insulating coating nominal thickness ranging from 0.26 to 0.30 mm; alternatively, a conductor cross-sectional area ranging from 0.65 to 0.85 mm², from 0.9 to 1.10 mm², or from 1.30 to 1.70 mm² with an insulating coating nominal thickness ranging from 0.33 to 0.37 mm; alternatively, a conductor cross-sectional area ranging from 0.44 to 0.56 mm², from 0.65 to 0.85 mm², from 0.9 to 1.10 mm², or from 1.30 to 1.70 mm² with an insulating coating nominal thickness ranging from 0.55 to 0.65 mm; alternatively, a conductor having a cross-sectional area of about 0.35 mm² with an insulating coating nominal thickness of about 0.25 mm; or alternatively, a conductor having a cross-sectional area of about 0.50 mm² with an insulating coating nominal thickness of about 0.28 mm. Other combinations of conductor cross-sectional area and/or conductor diameter with coating nominal thickness are readily apparent from the present disclosure.

The coated conductor may be further described using features such as the number of cycles the insulating coating can maintain its insulating properties under the scrape abrasion resistance test, the amount of force require to remove a portion of the insulating coating from the conductor (i.e. strip force), a reduction in the amount of force necessary to remove a portion of the insulating coating from the conductor as compared to another coating composition, and/or the ability of the coated conductor to pass the short-term heat aging test.

Generally, the ability of a coating to maintain its insulating properties under the scrape abrasion resistance test and the force required to remove a portion of insulating coating from the coated conductor may be a function of one more factors including conductor cross-sectional area, diameter of the conductor, and coating nominal thickness. Tables 3, 4, 5, 6, 7, and 8 provide examples of the minimum number of cycles that a coated conductor may maintain its insulating properties per ISO 6722 for a conductor having the specified conductor cross-sectional are and coating nominal thickness. The properties may be applied to any coated conductor having a cross-sectional area and coating nominal thickness falling within the range (inclusive of the range endpoints).

TABLE 3
Combinations of Conductor Cross-Sectional Area, Coating
Nominal Thickness, and Minimum Number of Cycles Completed
Under theScrape Abrasion Resistance Test

| | Conductor Cross-Sectional Area, mm² | | | | | |
|---|---|---|---|---|---|---|
| | 0.10-0.16 | 0.18-0.26 | 0.30-0.40 | 0.44-0.56 | 0.65-0.85 | 0.9-1.10 |
| | Coating Nominal Thickness, mm | | | | | |
| | 0.18-0.22 | 0.18-0.22 | 0.18-0.22 | 0.18-0.22 | 0.18-0.22 | 0.18-0.22 |
| Potential Minimum | 75 | 100 | 100 | 150 | 150 | 200 |
| Number of Scrape | 110 | 150 | 150 | 225 | 225 | 300 |
| Abrasion Resistance | 150 | 200 | 200 | 300 | 300 | 400 |
| Cycles per ISO 6722 | 185 | 300 | 300 | 375 | 375 | 500 |
| | 225 | 400 | 400 | 450 | 450 | 600 |

TABLE 4
Combinations of Conductor Cross-Sectional Area, Coating
Nominal Thickness, and Minimum Number of Cycles
Completed Under the Scrape Abrasion Resistance Test

| | Conductor Cross-Sectional Area, mm² | | | | | |
|---|---|---|---|---|---|---|
| | 1.30-1.70 | 1.8-2.2 | 2.30-2.70 | 0.10-0.16 | 0.17-0.25 | 0.30-0.40 |
| | Coating Nominal Thickness, mm | | | | | |
| | 0.18-0.22 | 0.23-0.27 | 0.23-0.27 | 0.23-0.27 | 0.23-0.27 | 0.23-0.27 |
| Potential Minimum | 200 | 300 | 300 | 150 | 150 | 200 |
| Number of Scrape | 300 | 450 | 450 | 225 | 225 | 300 |
| Abrasion Resistance | 400 | 600 | 600 | 300 | 300 | 400 |
| Cycles per ISO 6722 | 500 | 750 | 750 | 375 | 375 | 500 |
| | 600 | 900 | 900 | 450 | 450 | 600 |

TABLE 5
Combinations of Conductor Cross-Sectional Area, Coating Nominal Thickness, and Minimum
Number of Cycles Completed Under theScrape Abrasion Resistance Test

| | | | | | | |
|---|---|---|---|---|---|---|
| Conductor Cross- | 0.44-0.56 | 0.65-0.85 | 0.9-1.10 | 1.30-1.70 | 1.8-2.2 | 2.30-2.70 |
| Sectional Area, mm² | | | | | | |
| Coating Nominal | 0.26-0.30 | 0.28-0.32 | 0.28-0.32 | 0.28-0.32 | 0.33-0.37 | 0.33-0.37 |
| Thickness, mm | | | | | | |
| Potential Minimum | 300 | 350 | 500 | 1500 | 1500 | 1500 |
| Number of Scrape | 450 | 525 | 750 | 2250 | 2250 | 2250 |
| Abrasion Resistance | 600 | 700 | 1000 | 3000 | 3000 | 3000 |
| Cycles per ISO 6722 | 750 | 875 | 1250 | 3750 | 3750 | 3750 |
| | 900 | 1050 | 1500 | 4500 | 4500 | 4500 |

TABLE 6
Combinations of Conductor Cross-Sectional Area, Coating Nominal Thickness,
and Minimum Number ofCycles Completed Under the Scrape Abrasion Resistance Test

| | | | | | |
|---|---|---|---|---|---|
| Conductor Cross-Sectional | 2.80-3.20 | 3.75-4.25 | 4.70-5.30 | 5.60-6.40 | 9.00 to 11.0 |
| Area, mm² | | | | | |
| Coating Nominal | 0.38-0.42 | 0.38-0.42 | 0.38-0.42 | 0.38-0.42 | 0.55-0.65 |
| Thickness, mm | | | | | |
| Potential Minimum | 1500 | 1500 | 1500 | 1500 | 2000 |
| Number of Scrape | 2250 | 2250 | 2250 | 2250 | 3000 |
| Abrasion Resistance | 3000 | 3000 | 3000 | 3000 | 4000 |
| Cycles per ISO 6722 | 3750 | 3750 | 3750 | 3750 | 5000 |
| | 4500 | 4500 | 4500 | 4500 | 6000 |

TABLE 7
Combinations of Conductor Cross-Sectional Area, Coating Nominal Thickness, and Minimum
Number of Cycles Completed Under the Scrape Abrasion Resistance Test

| | | | | | | |
|---|---|---|---|---|---|---|
| Conductor Cross- | 0.44-0.56 | 0.65-0.85 | 0.9-1.10 | 1.30-1.70 | 1.8-2.2 | 2.30-2.70 |
| Sectional Area, mm² | | | | | | |
| Coating Nominal | 0.55-0.65 | 0.55-0.65 | 0.55-0.65 | 0.55-0.65 | 0.55-0.65 | 0.65-0.75 |
| Thickness, mm | | | | | | |
| Potential Minimum | 600 | 700 | 1000 | 1500 | 1500 | 2000 |
| Number of Scrape | 900 | 1050 | 1500 | 2250 | 2250 | 3000 |
| Abrasion Resistance | 1200 | 1400 | 2000 | 3000 | 3000 | 4000 |
| Cycles per ISO 6722 | 1500 | 1750 | 2500 | 3750 | 3750 | 5000 |
| | 1800 | 2100 | 3000 | 4500 | 4500 | 6000 |

TABLE 8
Combinations of Conductor Cross-Sectional Area, Coating Nominal Thickness,
and Minimum Number of Cycles Completed Under the Scrape Abrasion Resistance Test

| | | | | | |
|---|---|---|---|---|---|
| Conductor Cross-Sectional | 2.80-3.20 | 3.75-4.25 | 4.70-5.30 | 5.60-6.40 | 9.00 to 11.0 |
| Area, mm² | | | | | |
| Coating Nominal | 0.65-0.75 | 0.75-0.85 | 0.75-0.85 | 0.75-0.85 | 0.90-1.10 |
| Thickness, mm | | | | | |
| Potential Minimum | 2000 | 2500 | 2500 | 2500 | 3000 |
| Number of Scrape | 3000 | 3750 | 3750 | 3750 | 4500 |
| Abrasion Resistance | 4000 | 5000 | 5000 | 5000 | 6000 |
| Cycles per ISO 6722 | 5000 | 6750 | 6750 | 6750 | 7500 |
| | 6000 | 7500 | 7500 | 7500 | 9000 |

Tables 9, 10, 11, 12, 13, and 14 provide examples of the maximum force necessary to remove a portion of the coating from a coated conductor per ISO 6722 (strip force) or BMW BMW Group Standard GS 95007-1 for a conductor having the specified conductor cross-sectional area and coating nominal thickness. The strip force property may be applied to any coated conductor having a cross-sectional area and coating nominal thickness falling within the range (inclusive of the range endpoints).

TABLE 9
Combinations of Conductor Cross-Sectional Area, Coating Nominal Thickness, and ISO or
BMW Strip Force.

| | | | | | | |
|---|---|---|---|---|---|---|
| Conductor Cross- | 0.10-0.16 | 0.18-0.26 | 0.30-0.40 | 0.44-0.56 | 0.65-0.85 | 0.9-1.10 |
| Sectional Area, mm² | | | | | | |
| Coating Nominal | 0.18-0.22 | 0.18-0.22 | 0.18-0.22 | 0.18-0.22 | 0.18-0.22 | 0.18-0.22 |
| Thickness, mm | | | | | | |
| Potential Maximum | 25 | 25 | 30 | 35 | 35 | 35 |
| Strip Force, N, | 21 | 21 | 25 | 30 | 30 | 30 |
| per ISO 6722 or | 17 | 17 | 20 | 25 | 25 | 25 |
| BMW Group Standard | 13 | 13 | 15 | 20 | 20 | 20 |
| GS 95007-1 | | | | | | |

TABLE 10
Combinations of Conductor Cross-Sectional Area, Coating Nominal Thickness, and ISO or
BMW Strip Force.

| | | | | | | |
|---|---|---|---|---|---|---|
| Conductor Cross- | 1.30-1.70 | 1.8-2.2 | 2.30-2.70 | 0.10-0.16 | 0.17-0.25 | 0.30-0.40 |
| Sectional Area, mm² | | | | | | |
| Coating Nominal | 0.18-0.22 | 0.23-0.27 | 0.23-0.27 | 0.23-0.27 | 0.23-0.27 | 0.23-0.27 |
| Thickness, mm | | | | | | |
| Potential Maximum | 40 | 45 | 50 | 30 | 30 | 40 |
| Strip Force, N, | 35 | 40 | 45 | 25 | 25 | 35 |
| per ISO 6722 or | 30 | 35 | 40 | 20 | 20 | 30 |
| BMW Group Standard | 25 | 30 | 35 | 15 | 15 | 25 |
| GS 95007-1 | | | | | | |

TABLE 11
Combinations of Conductor Cross-Sectional Area, Coating Nominal Thickness, and ISO or
BMW Strip Force

| | | | | | | |
|---|---|---|---|---|---|---|
| Conductor Cross- | 0.44-0.56 | 0.65-0.85 | 0.9-1.10 | 1.30-1.70 | 1.8-2.2 | 2.30-2.70 |
| Sectional Area, mm² | | | | | | |
| Coating Nominal | 0.26-0.30 | 0.28-0.32 | 0.28-0.32 | 0.28-0.32 | 0.33-0.37 | 0.33-0.37 |
| Thickness, mm | | | | | | |
| Potential Maximum | 40 | 50 | 50 | 60 | 60 | 70 |
| Strip Force, N, | 35 | 45 | 45 | 50 | 50 | 60 |
| per ISO 6722 or | 30 | 40 | 40 | 5045 | 45 | 55 |
| BMW Group Standard | 25 | 35 | 35 | 40 | 40 | 50 |
| GS 95007-1 | | | | | | |

TABLE 12
Combinations of Conductor Cross-Sectional Area, Coating Nominal Thickness, and ISO or
BMW Strip Force.

| | | | | | |
|---|---|---|---|---|---|
| Conductor Cross-Sectional | 2.80-3.20 | 3.75-4.25 | 4.70-5.30 | 5.60-6.40 | 9.00 to 11.0 |
| Area, mm² | | | | | |
| Coating Nominal | 0.38-0.42 | 0.38-0.42 | 0.38-0.42 | 0.38-0.42 | 0.55-0.65 |
| Thickness, mm | | | | | |
| Potential Maximum | 75 | 80 | 80 | 80 | 85 |
| Strip Force, N, | 65 | 70 | 70 | 70 | 75 |
| per ISO 6722 or | 60 | 65 | 65 | 65 | 70 |
| BMW Group Standard | 55 | 60 | 60 | 60 | 65 |
| GS 95007-1 | | | | | |

TABLE 13
Combinations of Conductor Cross-Sectional Area, Coating Nominal Thickness, and ISO or
BMW Strip Force.

| | | | | | | |
|---|---|---|---|---|---|---|
| Conductor Cross- | 0.44-0.56 | 0.65-0.85 | 0.9-1.10 | 1.30-1.70 | 1.8-2.2 | 2.30-2.70 |
| Sectional Area, mm² | | | | | | |
| Coating Nominal | 0.55-0.65 | 0.55-0.65 | 0.55-0.65 | 0.55-0.65 | 0.55-0.65 | 0.65-0.75 |
| Thickness, mm | | | | | | |
| Potential Maximum | 110 | 120 | 120 | 130 | 140 | 140 |
| Strip Force, N, | 90 | 100 | 100 | 110 | 120 | 120 |
| per ISO 6722 or | 80 | 90 | 90 | 100 | 110 | 110 |
| BMW Group Standard | 70 | 80 | 80 | 90 | 100 | 100 |
| GS 95007-1 | | | | | | |

TABLE 14
Combinations of Conductor Cross-Sectional Area, Coating Nominal Thickness, and ISO or
BMW Strip Force.

| | | | | | |
|---|---|---|---|---|---|
| Conductor Cross-Sectional | 2.80-3.20 | 3.75-4.25 | 4.70-5.30 | 5.60-6.40 | 9.00 to 11.0 |
| Area, mm² | | | | | |
| Coating Nominal | 0.65-0.75 | 0.75-0.85 | 0.75-0.85 | 0.75-0.85 | 0.90-1.10 |
| Thickness, mm | | | | | |
| Potential Maximum | 140 | 150 | 160 | 160 | 160 |
| Strip Force, N, | 120 | 130 | 140 | 140 | 140 |
| per ISO 6722 or | 110 | 120 | 130 | 130 | 130 |
| BMW Group Standard | 100 | 110 | 120 | 120 | 120 |
| GS 95007-1 | | | | | |

The coated conductor may further meet pass the ISO 6722 short-term heat aging test for Class A, B, C, D, E, F, or G coated conductors. Class A, B, C, D, E, F and G coated conductors use a temperature of 85±2° C., 100±2° C., 125±3° C., 150±3° C., 175±3° C., 200±3° C., and 225±3° C., respectively for the heat aging portion of the short-term heat aging test.

Standards for scrape abrasion resistance, strip force, and short-term heat aging may be set for specific application by an entity which utilizes the coated conductor in manufactured article. For automobile applications, One such standard is the BMW Group Standard for Low Tension Cables for Motor Vehicles GS 95007-1 of November 2002. In an embodiment, the coated conductor meets the minimum requirements, either singly or in any combination, the number of cycles under the scrape resistance test, strip force, and short-term heat aging as specified within BMW group standard GS 95007-1. Such minimum requirements also includes any modification of the ISO 6722 methods described within the BMW group standard GS 95007-1.

Per BMW group standard GS 95007-1, coated a conductor having a cross-sectional area of 0.35 mm² at a nominal thickness of 0.25 mm should be able to complete at least 200 cycle per the scrape abrasion resistance test per ISO 6722 while coated conductor having a cross-sectional area of 0.50 mm² at a nominal thickness of 0.28 mm should be able to complete at least 300 cycles. Additional minimum number of cycles for the scrape abrasion resistance as specified in BMW group standard GS 95007-1 are provided in Table 15.

TABLE 1
BMW group standard GS 95007-1 requirement for scrape abrasion resistance.

| | | | | | | | | | |
|---|---|---|---|---|---|---|---|---|---|
| Conductor Cross- | 0.22 | 0.35 | 0.5 | 0.75 | 1.0 | 1.5 | 2.5 | 4.0 | 6.0 |
| Sectional Area, mm² | | | | | | | | | |
| Coating Nominal | 0.25 | 0.25 | 0.28 | 0.30 | 0.30 | 0.30 | 0.35 | 0.40 | 0.40 |
| Thickness, mm | | | | | | | | | |
| Number of Scrape | 150 | 200 | 300 | 350 | 500 | 1500 | 1500 | 1500 | 1500 |
| Abrasion Resistance | | | | | | | | | |
| Cycles per ISO 6722 | | | | | | | | | |

Per BMW group standard GS 95007-1, a coated conductor having a cross-sectional area of 0.35 mm at a nominal thickness of 0.25 mm or a conductor having a cross-sectional area of 0.50 mm² at a nominal thickness of 0.28 mm should have a strip force ranging from 5 to 30 N per the BMW group standard GS 95007-1. Additional ranges for the strip force as specified in BMW group standard GS 95007-1 are provided in Table 16.

TABLE 16
BMW group standard GS 95007-1 requirements for Strip Force

| | | | | | | | | | |
|---|---|---|---|---|---|---|---|---|---|
| Conductor Cross-Sectional | 0.22 | 0.35 | 0.5 | 0.75 | 1.0 | 1.5 | 2.5 | 4.0 | 6.0 |
| Area, mm² | | | | | | | | | |
| Coating Nominal | 0.25 | 0.25 | 0.28 | 0.30 | 0.30 | 0.30 | 0.35 | 0.40 | 0.40 |
| Thickness, mm | | | | | | | | | |
| Minimum Strip Force, N | 3 | 5 | 5 | 5 | 5 | 10 | 10 | 10 | 10 |
| Potential Maximum | 20 | 30 | 30 | 40 | 40 | 50 | 60 | 70 | 70 |
| Strip Force, N, | | | | | | | | | |
| per ISO 6722 | | | | | | | | | |

Additionally, a coated conductor may meet the short-term heat aging test per the BMW group standard GS 95007-1 modifications of ISO 6722. In further embodiments, the coated conductor(s) described herein may meet all of the requirements specified in BMW group standard GS 95007-1.

Generally, the PPS compositions described herein may be utilized to produce/manufacture a coated conductor by extruding the PPS composition onto a conductor. In an embodiment, the method of manufacturing a conductor having a coating, may be a method including: extruding a composition comprising polyphenylene sulfide (PPS); a polymer comprising a polymer of a hydrocarbon olefin and an epoxy-containing olefin (e.g. a copolymer of ethylene and glycidyl methacrylate); and a thermoplastic ionomer resin onto the conductor to form a coated conductor. In some embodiments, the method of manufacturing a conductor having a coating, may be a method including: extruding pellets comprising polyphenylene sulfide (PPS); a polymer comprising a polymer of a hydrocarbon olefin and an epoxy-containing olefin (e.g. a copolymer of ethylene and glycidyl methacrylate); and a thermoplastic ionomer resin onto the conductor to form a coated conductor. In another embodiment, the method of manufacturing a conductor having a coating, may be a method including blending a composition having: polyphenylene sulfide (PPS); a polymer comprising a polymer of a hydrocarbon olefin and an epoxy-containing olefin (e.g. a copolymer of ethylene and glycidyl methacrylate); and a thermoplastic ionomer resin; extruding the composition into pellets; and extruding the pellets onto the conductor to form a coated conductor. In an embodiment, the composition may also include other materials described herein for utilization in the coating composition (e.g. metal carboxylate, or bisphosphate, among other materials) and/or other additives as described herein. In an embodiment, the elements of the composition may be described using any feature described herein. In an embodiment, the conductor may be described using any feature described herein. In an embodiment, the coating composition may have any feature described herein. In an embodiment, the coated conductor may have any feature described herein.

The coated conductors described herein may be utilized in a number of manufactured products that may need a coated conductor having the properties described herein (e.g. abrasion resistance, strip force, and/or short-term heat aging). Manufactured products which may utilize the coated conductors described herein may experience elevated temperature during its operation, have moving parts in the vicinity of the coated conductor, and/or experience significant movement due to the operation of the manufacture product. In an embodiment, the product which may comprise the coated conductors described herein may comprise an engine (e.g. internal combustion engine). Such engines generally require conductors (e.g., single conductors, groups of conductors, harnesses of conductors, etc.) to supply electrical energy to start/operate the engine and/or utilize coated conductors to control other parts of the product. In an embodiment, the product may be a vehicle. In an embodiment the vehicle may be an automobile, bus, truck, boat, and/or an airplane. Generally, automobiles include vehicle which are utilized to carry 1-10 persons and optionally their belonging including, but not limited to, passenger cars, SUVs, and jeeps. In an embodiment, vans and trucks (e.g. light duty trucks) may be considered an automobile when its primary purpose is to transport people and optionally their belongings. Generally, buses are commercial vehicles (not necessarily for profit) utilized to carry 5 to 200 persons and optionally their belongings. Generally, trucks (other than light duty trucks utilized to carry passengers and optionally their belongings) are commercial vehicles utilized to transport materials other than persons (with the exception of the driver(s)). In an embodiment, a van may be a truck when its primary purpose is to transport materials. Generally, an airplane is a vehicle utilized to transport people and or material via air.

In sum, PPS composition described herein generally result in a coating composition having abrasion resistance (e.g., in accordance to test standards in ISO 6722 9.3 or similar methods), reasonable strip force (e.g., in accordance to test standards in ISO 6722 7.2, or similar methods), lower strip force (e.g., in accordance to test standards in ISO 6722 7.2, or similar methods) and/or short-term heat aging (e.g., in accordance to test standards in ISO 6722 7.2, or similar methods) acceptable for coating conductors for use in automotive and other applications. It should be noted that there generally is a balance between higher abrasion resistance and lower strip force. Potential advantages of the present formulations are the production of coated conductors which can remain in service for longer periods of time. The electronic components are less likely to fail due to abrasion and higher temperatures.

### FORMULATION EXAMPLES

The following examples are set forth to provide those of ordinary skill in the art with a detailed description of how the techniques claimed herein are evaluated, and are not intended to limit the scope of what the inventors regard as their invention.

These examples are directed to formulations for wire coating. The coating material was extruded using a ZSK-40 twin screw extruder made by Werner & Pfleiderer, The extruded was equipped with a 2-inch screw with a Maddox head. The chemicals and materials were mixed in a Henschel mixer and added to the extruder in the percentages listed in Table 1. For the examples, extruder temperatures were approximately 270±10° C. over the various zones. Screw speeds were typically 180-200 rpms with a throughput of approximately 150 pounds per hour (lbs/hr). The die design was a four-hole type, typical of that used in polymer strand formation. Cooling of the polymer strand was accomplished with a 5 feet water bath at temperatures of approximately 80±5° C. The strands were cooled and chopped into pellets using a Conair T206 WDG Water Slide Strand Pelletizer at a pelletizer speed of 272 rpms. Pellets were collected and bagged with some moisture content. The pellets were then transferred to a metal pan and placed in an oven at 250° F. for at least four hours prior to coating wire.

TABLE 1
Exemplary Formulations.

| | Sample ID's | | | | | | | | | | | |
|---|---|---|---|---|---|---|---|---|---|---|---|---|
| | A1-A2 | B | C | D | E1-E3 | F1-F3 | G1-G2 | H | I | J | K | L |
| PR34 | 63.0 | 59.0 | 64.0 | 62.0 | 65.0 | 65.0 | 63.0 | 64.0 | 63.0 | 65.0 | 65.0 | |
| PR40 | | | | | | | | | | | | 65.0 |
| Elvaloy X5 | | | | | | 28.2 | | | | | | 28.2 |
| Surlyn 9320 | 5.6 | 6.3 | 5.6 | 5.6 | 5.60 | 5.6 | 5.6 | 5.6 | 5.6 | 5.6 | 5.6 | |
| Irganox 1010 | 1.2 | 1.2 | 1.2 | 1.2 | 1.20 | 1.2 | 1.2 | 1.2 | 1.2 | 1.2 | 1.2 | 1.2 |
| FO206 | | | | | | | | | | | 28.2 | |
| Lotader AX8840 | 28.2 | 31.5 | | 28.2 | 28.2 | | | 28.2 | 8.2 | | | |
| Lotader AX 8900 | | | 28.2 | | | | 28.2 | | 20.0 | 28.2 | | |
| Lotader AX 8950 | | | 28.2 | | | | | | | | | |
| ExxonMobil | | | | | | | | | | | | 5.6 |
| Escor AT320 | | | | | | | | | | | | |
| Reofos RDP | 2.0 | 1.0 | 1.0 | 1.0 | | | 2.0 | 1.0 | 2.0 | | | |
| MFA P6010 | | 1.0 | | | | | | | | | | |
| Zinc Stearate | | | | 2.0 | | | | | | | | |
| Total | 100.0 | 100.0 | 100.0 | 100.0 | 100.0 | 100.0 | 100.0 | 100.0 | 100.0 | 100.0 | 100.0 | 100.0 |

The LOTADER® AX8840 and FO206 resins are a random copolymer of ethylene and glycidyl methacrylate (GMA). The LOTADER® AX8900 and AX9950 resins are random terpolymers of ethylene, methyl acrylate, and GMA. The LOTADER® resins (elastomers) may be obtained from Arkema Inc. of Philadelphia, Pa. Tables 3, 4, 5, and 6 below provide additional information about the LOTADER® elastomers AX8840, AX8900, and AX8950. For FO206, it has a GMA content (FTIR) of 12% and a melt index (190° C., 2.16 kilogram) of 3 grams per 10 minutes.

TABLE 3
LOTADER ® AX8840 General Characteristics.

| Properties | Value | Unit | Test Method |
|---|---|---|---|
| Melt Index (190 C., 2.16 Kg) | 5 | g/10 mm | ASTM D 1238 |
| | | | ISO 1133 |
| Glycidyl Methacrylate content | 8 | % | FTIR |
| Melting temperature | 105/221 | ° C./° F. | DSC |
| Vicat Temperature | 87/189 | ° C./° F. | ASTM D |
| | | | 1525-82 |
| | | | ISO 306 |
| Hardness Shore D | 50 | — | ASTM |
| | | | D2240-85 |
| | | | ISO R527 |
| Young Modulus | 104/15100 | Mpa/psi | ASTM D 638 |
| | | | ISO R527 |
| Tensile Strength at break | 8/1160 | Mpa/psi | ASTM D 638 |
| | | | ISO R527 |
| Elongation at break | 420 | % | ASTM D 638 |
| | | | ISO R527 |
| Density | 0.94 | g/cm³ | ASTM 1505 |
| | | | ISO R1183 |

TABLE 4
LOTADER ® AX8900 General Characteristics.

| Properties | Value | Unit | Test Method |
|---|---|---|---|
| Melt Index (190 C., 2.16 Kg) | 6 | g/10 mm | ASTM D 1238 |
| | | | ISO 1133 |
| Methyl acrylate content | 24 | % | FTIR |
| Glycidyl Methacrylate content | 8 | % | FTIR |
| Melting temperature | 60/140 | ° C./° F. | DSC |
| Vicat Temperature | <40/104 | ° C./° F. | ASTM D 1525-82 |
| | | | ISO 306 |
| Hardness Shore A/Shore D | 64/18 | — | ASTM D2240-85 |
| | | | ISO 868 |
| Young Modulus | 8/1160 | Mpa/psi | ASTM D 638 |
| | | | ISO R527 |
| Tensile Strength at break | 4/580 | Mpa/psi | ASTM D 638 |
| | | | ISO R527 |
| Elongation at break | 1100 | % | ASTM D 638 |
| | | | ISO R527 |
| Density | 0.95 | g/cm³ | ASTM 1505 |
| | | | ISO R1183 |

TABLE 5
LOTADER ® AX8950 General Characteristics.

| Properties | Value | Unit | Test Method |
|---|---|---|---|
| Melt Index (190 C., 2.16 Kg) | 70-100 | g/10 mm | ASTM D 1238 |
| | | | ISO 1133 |
| Methyl acrylate content | 13-17 | % | FTIR |
| Glycidyl Methacrylate content | 7-11 | % | FTIR |
| Melting temperature | 71/160 | ° C./° F. | DSC |
| Vicat Temperature | <40/104 | ° C./° F. | ASTM D 1525-82 |
| | | | ISO 306 |
| Hardness Shore A | 63 | — | ASTM D2240-85 |
| | | | ISO 868 |
| Young Modulus | 7/1020 | Mpa/psi | ASTM D 638 |
| | | | ISO R527 |
| Tensile Strength at break | 2.8/400 | Mpa/psi | ASTM D 638 |
| | | | ISO R527 |
| Elongation at break | 450 | % | ASTM D 638 |
| | | | ISO R527 |
| Density | 0.95 | g/cm³ | ASTM 1505 |
| | | | ISO R1183 |

TABLE 6
LOTADER ® Glycidyl Methacrylate (GMA).

| | | | | | | | Tensile | | Hard- | |
|---|---|---|---|---|---|---|---|---|---|---|
| | | Melt | Melting | Vicat | Ester | Glycidyl | Strength at | Elongation | ness | |
| | | Index | Point | Point | Content | Methacrylate | Break | as Break | Shore | |
| Base | Grades | (g/10 min) | (° C./° F.) | (° C./° F.) | (%) | Content (%) | (Mpa/PSI) | (%) | A | D |
| E-GMA | AX8840 | 5 | 105/221 | 87/189 | 0 | 8 | 8/1160 | 420 | 92 | — |
| E-MA- | AX8900 | 6 | 60/140 | <40/<104 | 25 | 8 | 4/600 | 1100 | 64 | 18 |
| GMA | AX8950 | 85 | 71/160 | <40/<104 | 15 | 9 | 2.8/400 | 450 | 63 | — |

| | | | | | | | |
|---|---|---|---|---|---|---|---|
| Test Method | ASTM | D.S.C. | ASTM D | IR | IR | ASTM D 638 | ASTM |
| | | D 1238 | | 638 | | | D 2240 |

Elvaloy® X5 is an elastomer and a random terpolymer of ethylene, butyl acrylate, and GMA. Elvaloy® X5 is available from E. I. duPont De Nemours of Wilmington Del. Escor™ AT320 is a terpolymer of ethylene, methacrylate, and acrylic acid, and has a methacrylate content of about 18% and an acrylic acid content of about 6%. Properties of Escor™ AT320 include a melt flow rate of about 5 grams per 10 minutes and a density of about 0.952 gram per cubic centimeter. Escor™ AT320 is available from ExxonMobil Chemical Company of Houston, Tex.

PR34 is a grade of PPS having a generally linear molecular structure and good flow characteristics. PR34 has a melt flow rate (ASTM D1283 procedure B, 316° C. melt temperature, 5 kilogram weight) of approximately 370 grams per 10 minutes. PR36 is a grade of PPS having a branched molecular structure and a melt flow rate of approximately 30-70 grams per 10 minutes. Both PR34 and PR36 are available from Chevron Phillips Chemical Company LP of The Woodlands, Tex.

The Reofos RDP is tetraphenyl resorcinol diphosphate, and is commonly employed as a thermal stability agent and flame retardant. As mentioned, Reofos RDP available from by Great Lakes Chemical Corporation (now Chemtura Corporation) of Middlebury, Connecticut. Hyflon® MFA P6010 is a clear, semi-crystalline melt-processable perfluorinated resin providing thermal resistance, flame resistance, and other properties. Hyflon® MFA P6010 is available from Solvay of Brussels, Belgium.

Surlyn® is a commercial thermoplastic ionomer resin. Surlyn® is the random copolymer ethylene and methacrylic acid. The incorporation of methacrylic acid is typically low (<15 mol. %). Surlyn® ionomer resins may be obtained from DuPont of Wilmington, Del.

Coated conductors were made from the compositions provided in Table 1. The conductors used were either a copper conductor having a cross-section area of 0.35 mm² comprised of 7 strands having a 0.255 mm diameter or a copper conductor having a cross-section area of 0.50 mm² comprised of 19 strands having a 0.180 mm diameter. The conductors were coated using a Kinney ED-X-TRUDER Model 125X201 extruder equipped with a 1 ½-inch screw and a crosshead die. Barrel and die temperatures were typically set at 560±10° F. Typically, the line speed was kept at 175±10 feet per minute (fpm) while samples were collected. This generally resulted in a screw speed of 40±5 rpms. Eccentricity of the wire was managed using a Sikora Centerview 2010. The conductor was fed with a TulsaPower Model TH-PO-REFUR8 payoff and taken up on a TulsaPower Model TM-TU takeup.

TABLE 2
Strip Force, Abrasion Resistance, and Short-Term Heat Aging per ISO 6722

| | | | | | | | | | | Class D Short- |
|---|---|---|---|---|---|---|---|---|---|---|
| | | | | | | | | | | Term Heat |
| | Wire | | | | | | | | | Aging |
| Sample | Size | Strip Force (N) | | | | Abrasion Resistance (cycles) | | | | Pass/ |
| ID's | (mm) | 1 | 2 | 3 | Avg | 1 | 2 | 3 | Avg | Fail |
| A1 | 0.50 | 41.1 | 35.1 | 39.5 | 38.5 | 1,153 | 1,082 | 1,187 | 1,141 | PASS |
| A2 | 0.50 | 34.0 | 41.8 | 37.0 | 37.6 | 876 | 613 | 718 | 735.7 | PASS |
| B | 0.50 | 32.4 | 44.2 | 29.7 | 35.5 | 727 | 546 | 559 | 610.7 | FAIL |
| C | 0.50 | 49.6 | 26.7 | 34.8 | 37.0 | 183 | 243 | 224 | 216.7 | PASS |
| D | 0.50 | 19.4 | 35.5 | 20.9 | 25.3 | 414 | 486 | 487 | 462.3 | PASS |
| E1 | 0.35 | 36.3 | 35.9 | 37.7 | 36.6 | 842 | 884 | 712 | 813 | PASS |
| E2 | 0.35 | 37.0 | 40.9 | 37.0 | 38.3 | 859 | 672 | 762 | 764 | PASS |
| E3 | 0.50 | 31.5 | 47.2 | NR | 39.4 | 913 | 992 | 925 | 943 | PASS |
| F1 | 0.35 | 18.9 | 18.9 | 16.3 | 18.1 | 67 | 39 | 58 | 55 | FAIL |
| F2 | 0.35 | 30.0 | 20.3 | 21.8 | 24.0 | 80 | 67 | 45 | 64 | FAIL |
| F3 | 0.50 | 29.2 | 43.1 | NR | 36.1 | 124 | 140 | 103 | 122 | PASS |
| G1 | 0.35 | 19.0 | 20.6 | 23.4 | 21.0 | 86 | 53 | 105 | 81 | PASS |
| G2 | 0.50 | 26.2 | 37.5 | 27.5 | 30.4 | 317 | 299 | 295 | 304 | PASS |
| H | 0.50 | 31.7 | 48.4 | 38.4 | 39.5 | 412 | 748 | 463 | 541 | FAIL |
| I | 0.50 | 28.5 | 40.5 | 45.7 | 38.2 | 410 | 314 | 344 | 356 | PASS |
| J | 0.35 | 27.0 | 31.4 | 31.0 | 29.8 | 176 | 156 | 194 | 175 | PASS |
| K | 0.35 | 20.2 | 18.4 | 21.2 | 19.9 | 197 | 222 | 190 | 203 | PASS |
| L | 0.50 | 45 | 31 | 25 | 33.7 | 193 | 254 | 263 | 236.67 | PASS |

Reviewing Table 2, it can be seen that to improve abrasion resistance, the use of LOTADER® AX8840 elastomer is most beneficial in these examples. The elastomer comparisons are as follows: C vs. H; F1-F2 vs. E1-E2; F3 vs. E3; G2 and I vs. A1/A2; J, K and L vs. E1/E2. These comparisons affirm that the use of AX8840 enhances abrasion resistance of the compounds versus other elastomers. To pass the abrasion test per BMW group standard GS 95007-1, a 0.35 mm² wire must complete 200 cycles without losing conductivity and a 0.50 mm² wire must pass 300 cycles. Moreover, formulations with and without Reofos RDP indicate that Reofos RDP (a bisphosphate) plays a role in reducing the effects of short-term heat aging (G1 v. F1), as well as having an effect to decrease the strip force (i.e., the force required to remove the coating) (A2 vs. E3). Zinc stearate, however, apparently demonstrates the largest effect on strip force (D vs. E3, A1, A2). In the exemplary comparison of A1-A2 versus D, the inclusion of zinc stearate reduced the strip force by about 34%.

Moreover, it should be noted that zinc stearate has a greater impact than other lubricants (e.g., polytetrafluorethylene or PTFE and siloxane) separately tested. For example, in one comparison utilizing exemplary processing conditions discussed above, a coating formulation W (having weight percentages 69% PPS PR34, 25% DuPont Elvaloy X5, 5% DuPont Surlyn 9320, and 1% Irganox 1010) provided a strip force of about 18.1 N as compared to a formulation X (having 64% PPS PR34, 25% DuPont Elvaloy X5, 5% DuPont Surlyn 9320, 5% PTFE Polymist FSA, and 1% Irganox 1010) which provided a strip force of about 43.5 N. Thus, the formulation Y (which replaced a portion of the PR34 as compared to formulation X with a PTFE—a lubricant) did not reduce the strip force, as would be desired.

In another comparison, a formulation Y′ (having 65.5% PR34, 23.75% DuPont Elvaloy X5, 4.75% DuPont Surlyn 9320, 5% PTFE Polymist FSA, and 1% Irganox 1010) provided a strip force of about 15.8, which gave reduction in strip force of about 13% as compared to formulation X. However, even this marginal reduction may be questionable due to observations of thin areas of the coating during strip-force testing of the coating formulation Y′.

In yet another comparison utilizing the above exemplary process conditions, formulation H in Tables 1 and 2 which gave an average strip force of 39.5 N is compared with a formulation Y (having weight percentages 62% PPS PR34, 5.6% Surlyn 9320, 1.2% Irganox 1010, 25.2% LOTADER® AX8840, 1% Reofos RDP, and 2% zinc stearate) providing a strip force of about 25 N, and also compared with a formulation Z (having weight percentages 62% PPS PR34, 5.6% Surlyn 9320, 1.2% Irganox 1010, 25.2% LOTADER® AX8840, 1% Reofos RDP, and 2% siloxane) providing a strip force of about 38 N. Thus, the use of zinc stearate (a metal carboxylate) provides a significantly greater reduction is strip force than the use of the lubricant siloxane.

It should be noted that for all abrasion test (cycles) data throughout this disclosure, the test were conducted per ISO 9722 9.3, and the diameter of the needle per ISO 9.3.2 was 0.45±0.01 mm. All strip force data tabulated herein was generated per ISO 9722 7.2. Lastly, the short-term heat aging testing (results listed on Tables 1 and 2) was conducted per ISO 9722 10.1 (short-term aging) for a Class D rating.

In sum, embodiments of the present techniques may provide for a composition or conductor coating incorporating polyphenylene sulfide (PPS), a random copolymer of ethylene and glycidyl methacrylate, and a thermoplastic ionomer resin. In examples, this conductor coating may be applied to a 0.50 mm² conductor at a nominal thickness of 0.28 mm. In these examples, the coating of the coated conductor may have an abrasion resistance of at least about 600 cycles per ISO 6722 and a strip force less than about 35 Newtons (N) per ISO 6722. Further the coating of the coated conductor may pass the short-term heat aging test per ISO 6722 for a class D rating. As discussed, incorporating metal carboxylate into the coating may facilitate these properties.

A present method of manufacturing a conductor having a coating may include mixing a formulation, the formulation having polyphenylene sulfide (PPS), a random copolymer of ethylene and glycidyl methacrylate, a thermoplastic ionomer resin, and a metal carboxylate. In one example, the mixed formulation may then be extruded onto the conductor to form the coated conductor. On the other hand, the mixed formulation is first extruded into pellets, and the pellets then extruded onto the conductor. Also, as indicated, the conductor or wiring coated with embodiments of the present coating may be incorporated into a variety of products, such as vehicles.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A conductor coating comprising:
polyphenylene sulfide (PPS);
a random copolymer of ethylene and glycidyl methacrylate;
a thermoplastic ionomer resin; and
a metal carboxylate.

2. The conductor coating as recited in claim 1, wherein the metal carboxylate is derived from a carboxylic acid having from 15 to 30 carbon atoms.

3. The conductor coating as recited in claim 1, wherein the metal carboxylate comprises zinc stearate.

4. The conductor coating as recited in claim 1, wherein the random copolymer has a glycidyl methacrylate content in the range of about 6 to about 10 weight %.

5. The conductor coating as recited in claim 1, wherein the conductor coating comprises:
from about 40 to about 90 weight % PPS;
from about 5 to about 50 weight % random copolymer of ethylene and glycidyl methacrylate;
from about 0.5 to about 25 weight % thermoplastic ionomer resin; and
from about 0.5 to about 5 weight % metal carboxylate.

6. The conductor coating as recited in claim 1, wherein applying the coating to a conductor having a cross-sectional area of about 0.50 mm² at a nominal thickness of 0.28 mm produces a coated conductor and the addition of the metal carboxylate into the conductor coating reduces the strip force of the conductor coating by at least about 20% per ISO 6722.

7. The conductor coating as recited in claim 1, wherein applying the coating to a conductor having a cross-sectional area of about 0.50 mm² at a nominal thickness of 0.28 mm produces a coated conductor and the conductor coating has an abrasion resistance of at least about 600 cycles per ISO 6722.

8. The conductor coating as recited in claim 1, wherein applying the coating to a conductor having a cross-sectional area of about 0.50 mm² at a nominal thickness of 0.28 mm produces a coated conductor and the conductor coating has a strip force less than about 35 N per ISO 6722.

9. The conductor coating as recited in claim 1, wherein applying the coating to a conductor having a cross-sectional area of about 0.50 mm² at a nominal thickness of 0.28 mm produces a coated conductor and the conductor coating passes the short-term heat aging test per ISO 6722 for a class D rating.

10. A conductor coating comprising:
polyphenylene sulfide (PPS);
a random copolymer of ethylene and glycidyl methacrylate;
a thermoplastic ionomer resin; and
an organic bisphosphate.

11. The conductor coating as recited in claim 10, wherein the organic bisphosphate comprises tetraphenyl resorcinol diphosphate.

12. The conductor coating as recited in claim 10, wherein the conductor coating comprises:
from about 40 to about 90 weight % PPS;
from about 5 to about 50 weight % copolymer of ethylene and glycidyl methacrylate;
from about 0.5 to about 25 weight % thermoplastic ionomer resin; and
from about 0.5 to about 5 weight % organic bisphosphate.

13. The conductor coating as recited in claim 10, wherein applying the coating to a conductor having a cross-sectional area of about 0.50 mm² at a nominal thickness of 0.28 mm produces a coated conductor and the conductor coating passes the short-term heat aging test per ISO 6722 for a class D rating.

14. A conductor coating comprising:
polyphenylene sulfide (PPS);
a random copolymer of ethylene and glycidyl methacrylate;
a thermoplastic ionomer resin;
metal carboxylate; and
an organic bisphosphate.

15. The conductor coating recited in claim 14, wherein the coating formulation comprises:
about 40% to about 90% by weight PPS;
about 5% to about 50% by weight random copolymer of ethylene and glycidyl methacrylate;
about 0.5% to about 25% by weight thermoplastic ionomer resin;
about 0.5% to about 5% by weight organic bisphosphate; and
about 0.5% to about 5% by weight metal carboxylate.

16. The conductor coating as recited in claim 14, wherein applying the coating to a conductor having a cross-sectional area of about 0.50 mm² at a nominal thickness of 0.28 mm produces a coated conductor and wherein the conductor coating has an abrasion resistance of at least about 400 cycles per ISO 6722, has a strip force less that 30 N per ISO 6722, and passes the short-term neat aging test per ISO 6722 for a class D rating.

17. A coated conductor comprising:
a conductor having diameter ranging from about 0.4 to about 5 mm coated with an insulating coating, the insulating coating having a nominal thickness ranging from about 0.2 to 1.0 mm, and the insulating coating comprising:
polyphenylene sulfide (PPS);
a random copolymer of ethylene and glycidyl methacrylate; and
a thermoplastic ionomer resin.

18. The coated conductor as recited in claim 17, wherein the insulating coating further comprises a metal carboxylate.

19. The coated conductor as recited in claim 17, wherein the insulating coating further comprises an organic bisphosphate.

20. The coated conductor as recited in claim 18, wherein the insulating coating comprises:
a. from about 40 to about 90 weight % PPS;
b. from about 5 to about 50 weight % random copolymer of ethylene and glycidyl methacrylate;
c. from about 0.5 to about 25 weight % thermoplastic ionomer resin; and
d. from about 0.5 to about 5 weight % metal carboxylate.

21. The coated conductor as recited in claim 20, wherein the conductor has a cross-sectional area ranging from 0.44 to 0.56 mm² and the insulating coating has a nominal thickness ranging from 0.26 to 0.30 mm, and wherein the insulating coating has an abrasion resistance of at least about 600 cycles per ISO 6722, a strip force less that 30 N per ISO 6722, and passes the short-term heat aging test per ISO 6722 for a class D rating.

22. The coated conductor as recited in claim 20, wherein the conductor has a cross-sectional area ranging from 0.30 to 0.40 mm² and the insulating coating has a nominal thickness ranging from 0.23 to 0.27 mm, and wherein the insulating coating has an abrasion resistance of at least about 500 cycles per ISO 6722, a strip force less that 30 N per ISO 6722, and passes the short-term heat aging test per ISO 6722 for a class D rating.

23. A product comprising:
a coated conductor, the coating comprising:
polyphenylene sulfide (PPS);
a random copolymer of ethylene and glycidyl methacrylate;
a thermoplastic ionomer resin; and
a metal carboxylate.

24. The product of claim 23, wherein the product comprises a vehicle.

25. The product of claim 23, wherein the conductor comprises a wire.

26. A method of manufacturing a conductor having a coating, the method comprising:
blending a composition comprising: polyphenylene sulfide (PPS); a random copolymer of ethylene; glycidyl methacrylate; a thermoplastic ionomer resin; and a metal carboxylate;
extruding the composition into pellets; and
extruding the pellets onto the conductor to form a coated conductor.

27. A conductor coating comprising:
polyphenylene sulfide (PPS);
a random copolymer of ethylene and glycidyl methacrylate; and
a thermoplastic ionomer resin, wherein applying the conductor coating to a conductor having a cross-sectional area of about 0.50 mm² at a nominal thickness of 0.28 mm produces a coated conductor, wherein the conductor coating of the coated conductor comprises an abrasion resistance of at least about 600 cycles per ISO 6722 and a strip force less than about 35 N per ISO 6722, and wherein the conductor coating of the coated conductor passes the short-term heat aging test per ISO 6722 for a class D rating.
